(19) United States
(12) Patent Application Publication
(10) Pub. No.: US 2011/0294384 A1
(43) Pub. Date: Dec. 1, 2011

(54) PHOTOCHEMICAL CROSS-LINKABLE POLYMERS, METHODS OF MAKING PHOTOCHEMICAL CROSS-LINKABLE POLYMERS, AND METHODS OF USING PHOTOCHEMICAL CROSS-LINKABLE POLYMERS

(76) Inventors: Jason Locklin, Bogart, GA (US); Ian Hardin, Athens, GA (US); Satyabrata Samanta, Fargo, ND (US); Vikram Dhende, Athens, GA (US)

(21) Appl. No.: 13/147,295

(22) PCT Filed: Feb. 17, 2010
(86) PCT No.: PCT/US2010/024422

§ 371 Date: Aug. 1, 2011

Related U.S. Application Data
(60) Provisional application No. 61/153,385, filed on Feb. 18, 2009.

(51) Int. Cl. B32B 27/04; C08J 3/24; C08J 7/04; C08G 73/02

(52) U.S. Cl. 442/123; 525/471; 427/508; 427/513

(57) ABSTRACT

Briefly described, embodiments of this disclosure include, among others, polymer compositions, methods of making polymer compositions, structures having the polymer composition covalently bonded to the surface of the structure, methods of attaching the polymer to the surface of the structure, methods of decreasing the amount of microorganisms formed on a structure, and the like.

### CROSS-REFERENCE TO RELATED APPLICATION

This application claims priority to U.S. provisional applications entitled, “PHOTOCHEMICAL CROSS-LINKABLE POLYMERS, METHODS OF MAKING PHOTOCHEMICAL CROSS-LINKABLE POLYMERS, AND METHODS OF USING PHOTOCHEMICAL CROSS-LINKABLE POLYMERS,” having Ser. No. 61/153,385, filed on Feb. 18, 2009, which is entirely incorporated herein by reference.

### BACKGROUND

Microbial infection and contamination is one of the most serious concerns in several areas of life such as textiles, food packaging, processing and storage, water purification, medical devices, drugs and dental surgery equipment. Recently antimicrobial agents have gained more interested from both academic and industrial points of view because of their potential to provide safety benefits to many materials. Some cationic polymers, such as quaternary polyetheleneimines (QPEIs), have proven to be effective at killing bacteria because of their unique structural properties. The proposed mechanism for antimicrobial activity of polycations is through the disruption of cell membranes, causing breakdown of the transmembrane potential, leakage of cytoplasmic contents, and ultimately cell death. Under this mechanism, the positive charge (or dipole differential) on the vicinity of the quaternary nitrogen atom is relevant to the membrane-disrupting ability of polycations. The overall charge may be enhanced by ligation of electron withdrawing groups in the vicinity of the cation centers (e.g., α- and/or β-halides, nitro and sulfonium groups) and/or use of electronegative (or “hard”) counter-ions (e.g, BF₄⁻, SO₄²⁻). A more detailed mechanism for rapid contact killing of bacteria at a solid interface remains an important area of research. To achieve this goal, the development of new methodology for surfaces with well defined properties is necessary. A few literature reports concerning the preparation of antimicrobial surfaces via the covalent coupling of poly quaternary ammonium (PQA) compounds to a variety of surfaces has been demonstrated. The covalent attachment of biocidal polymers on common and inert plastic surfaces however, is much more challenging due to the lack of reactive functional groups. Recently, Matyjaszewski's group was able to modify polypropylene surfaces by combining a novel photochemical method with a controlled/living radical polymerization technique, atom transfer radical polymerization (ATRP) (Biomacromolecules 2007, 8, 1396-1399). This is an intelligent approach to functionalize inert surfaces but this surface initiated polymerization is not practical for commercialization. Therefore, there is a need to provide a chemical and/or process for dealing with these problems.

### SUMMARY

Briefly described, embodiments of this disclosure include, among others, polymer compositions, methods of making polymer compositions, structures having the polymer composition covalently bonded to the surface of the structure, methods of attaching the polymer to the surface of the structure, methods of decreasing the amount of microorganisms formed on a structure, and the like.

One exemplary polymer, among others, includes: a linear or branched polyethylenimine polymer that has been quaternized with a hydrophobic side chain moiety and a photo cross-linkable moiety.

One exemplary method of disposing a polymer on a surface, among others, includes: providing a polymer as described herein; disposing the polymer on a structure having a surface having C—H groups; exposing the polymer to a UV light, wherein the interaction of the polymer with the UV light causes the polymer to covalently bond with the surface.

One exemplary structure, among others, includes: a surface having a polymer as described herein covalently attached to the surface, wherein the structure has an antimicrobial characteristic.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates the change in UV spectra of a benzophenone side-chain in polymer 2b with UV exposure time (360 nm).

FIG. 2 illustrates an AFM image for the film of polymer 2b (122 nm) before sonication with roughness of 0.48 nm.

FIG. 3 illustrates an AFM image for the film of polymer 2b (65 nm) after sonication with roughness of 0.83 nm.

FIG. 4 illustrates digital pictures of glass substrates that were sprayed with Staphylococcus Aureus. (a) control slide and (b) 65 nm thick polymer 2b.

FIG. 5 illustrates digital pictures of cotton strips that were sprayed with Staphylococcus Aureus. (a) control and (b) substrate spray coated with cross-linked polymer 2b.

FIG. 6 illustrates digital pictures of a polypropylene non-woven geotextiles that were sprayed with Staphylococcus aureus. (a) control and (b) substrate spray coated with cross-linked polymer 2b.

FIG. 7 illustrates digital pictures of polyvinylchloride coated polyester grid structures that were sprayed with Staphylococcus aureus (a) control and (b) substrate sponge dabbed with cross-linked polymer 2b solution (15 mg/ml) and laundered.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, biology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DEFINITIONS

As used herein, “alkyl” or “alkyl group” refers to a saturated aliphatic hydrocarbon chain and a substituted saturated aliphatic hydrocarbon chain which may be straight, branched, or cyclic, having 1 to 20 carbon atoms, where the stated range of carbon atoms includes each intervening integer individually, as well as sub-ranges. Examples of alkyl groups include, but are not limited to, methyl, ethyl, i-propyl, n-propyl, n-butyl, t-butyl, pentyl, hexyl, septyl, octyl, nonyl, decyl, and the like. The substitution can be with a halogen, for example.

The term “antimicrobial characteristic” refers to the ability to kill and/or inhibit the growth of microorganisms. A substance having an antimicrobial characteristic may be harmful to microorganisms (e.g., bacteria, fungi, protozoans, algae, and the like). A substance having an antimicrobial characteristic can kill the microorganism and/or prevent or substantially prevent the growth or reproduction of the microorganism.

The terms “bacteria” or “bacterium” include, but are not limited to, Gram positive and Gram negative bacteria. Bacteria can include, but are not limited to, Abiotrophia, Achromobacter, Acidaminococcus, Acidovorax, Acinetobacter, Actinobacillus, Actinobaculum, Actinomadura, Actinomyces, Aerococcus, Aeromonas, Afipia, Agrobacterium, Alcaligenes, Alloiococcus, Alteromonas, Amycolata, Amycolatopsis, Anaerobospirillum, Anabaena affinis and other cyanobacteria (including the Anabaena, Anabaenopsis, Aphanizomenon, Camesiphon, Cylindrospermopsis, Gloeobacter Hapalosiphon, Lyngbya, Microcystis, Nodularia, Nostoc, Phormidium, Planktothrix, Pseudoanabaena, Schizothrix, Spirulina, Trichodesmium, and Umezakia genera) Anaerorhabdus, Arachnia, Arcanobacterium, Arcobacter, Arthrobacter, Atopobium, Aureobacterium, Bacteroides, Balneatrix, Bartonella, Bergeyella, Bifidobacterium, Bilophila Branhamella, Borrelia, Bordetella, Brachyspira, Brevibacillus, Brevibacterium, Brevundimonas, Brucella, Burkholderia, Buttiauxella, Butyrivibrio, Calymmatobacterium, Campylobacter, Capnocytophaga, Cardiobacterium, Catonella, Cedecea, Cellulomonas, Centipeda, Chlamydia, Chlamydophila, Chromobacterium, Chyseobacterium, Chryseomonas, Citrobacter, Clostridium, Collinsella, Comamonas, Corynebacterium, Coxiella, Cryptobacterium, Delftia, Dermabacter, Dermatophilus, Desulfomonas, Desulfovibrio, Dialister, Dichelobacter, Dolosicoccus, Dolosigranulum, Edwardsiella, Eggerthella, Ehrlichia, Eikenella, Empedobacter, Enterobacter, Enterococcus, Erwinia, Erysipelothrix, Escherichia, Eubacterium, Ewingella, Exiguobacterium, Facklamia, Filifactor, Flavimonas, Flavobacterium, Francisella, Fusobacterium, Gardnerella, Gemella, Globicatella, Gordona, Haemophilus, Hafnia, Helicobacter, Helococcus, Holdemania Ignavigranum, Johnsonella, Kingella, Klebsiella, Kocuria, Koserella, Kurthia, Kytococcus, Lactobacillus, Lactococcus, Lautropia, Leclercia, Legionella, Leminorella, Leptospira, Leptotrichia, Leuconostoc, Listeria, Listonella, Megasphaera, Methylobacterium, Microbacterium, Micrococcus, Mitsuokella, Mobiluncus, Moellerella, Moraxella, Morganella, Mycobacterium, Mycoplasma, Myroides, Neisseria, Nocardia, Nocardiopsis, Ochrobactrum, Oeskovia, Oligella, Orientia, Paenibacillus, Pantoea, Parachlamydia, Pasteurella, Pediococcus, Peptococcus, Peptostreptococcus, Photobacterium, Photorhabdus, Phytoplasma, Plesiomonas, Porphyrimonas, Prevotella, Propionibacterium, Proteus, Providencia, Pseudomonas, Pseudonocardia, Pseudoramibacter, Psychrobacter, Rahnella, Ralstonia, Rhodococcus, Rickettsia Rochalimaea Roseomonas, Rothia, Ruminococcus, Salmonella, Selenomonas, Serpulina, Serratia, Shewenella, Shigella, Simkania, Slackia, Sphingobacterium, Sphingomonas, Spirillum, Spiroplasma, Staphylococcus, Stenotrophomonas, Stomatococcus, Streptobacillus, Streptococcus, Streptomyces, Succinivibrio, Sutterella, Suttonlla, Tatumella, Tissierella, Trabulsiella, Treponema, Tropheryma, Tsakamurella, Turicella, Ureaplasma, Vagococcus, Veillonella, Vibrio, Weeksella, Wolinella, Xanthomonas, Xenorhabdus, Yersinia, and Yokenella. Other examples of bacterium include Mycobacterium tuberculosis, M. bovis, M. typhimurium, M. bovis strain BCG, BCG substrains, M. avium, M. intracellulare, M. africanum, M. kansasii, M. marinum, M. ulcerans, M. avium subspecies paratuberculosis, Staphylococcus aureus, Staphylococcus epidermidis, Staphylococcus equi, Streptococcus pyogenes, Streptococcus agalactiae, Listeria monocytogenes, Listeria ivanovii, Bacillus anthracis, B. subtilis, Nocardia asteroides, and other Nocardia species, Streptococcus viridans group, Peptococcus species, Peptostreptococcus species, Actinomyces israelii and other Actinomyces species, and Propionibacterium acnes, Clostridium tetani, Clostridium botulinum, other Clostridium species, Pseudomonas aeruginosa, other Pseudomonas species, Campylobacter species, Vibrio cholera, Ehrlichia species, Actinobacillus pleuropneumoniae, Pasteurella haemolytica, Pasteurella multocida, other Pasteurella species, Legionella pneumophila, other Legionella species, Salmonella typhi, other Salmonella species, Shigella species Brucella abortus, other Brucella species, Chlamydi trachomatis, Chlamydia psittaci, Coxiella bumetti, Escherichia coli, Neiserria meningitidis, Neiserria gonorrhea, Haemophilus influenzae, Haemophilus ducreyi, other Hemophilus species, Yersinia pestis, Yersinia enterolitica, other Yersinia species, Escherichia coli, E. hirae and other Escherichia species, as well as other Enterobacteria, Brucella abortus and other Brucella species, Burkholderia cepacia, Burkholderia pseudomallei, Francisella tularensis, Bacteroides fragilis, Fudobascterium nucleatum, Provetella species, and Cowdria ruminantium, or any strain or variant thereof. The Gram-positive bacteria may include, but is not limited to, Gram positive Cocci (e.g., Streptococcus, Staphylococcus, and Enterococcus). The Gram-negative bacteria may include, but is not limited to, Gram negative rods (e.g., Bacteroidaceae, Enterobacteriaceae, Vibrionaceae, Pasteurellae and Pseudomonadaceae). In an embodiment, the bacteria can include Mycoplasma pneumoniae.

The term “protozoan” as used herein includes, without limitations flagellates (e.g., Giardia lamblia), amoeboids (e.g., Entamoeba histolitica), and sporozoans (e.g., Plasmodium knowlesi) as well as ciliates (e.g., B. coli). Protozoan can include, but it is not limited to, Entamoeba coli, Entamoeabe histolitica, Iodoamoeba buetschlii, Chilomastix meslini, Trichomonas vaginalis, Pentatrichomonas homini, Plasmodium vivax, Leishmania braziliensis, Trypanosoma cruzi, Trypanosoma brucei, and Myxoporidia.

The term “algae” as used herein includes, without limitations microalgae and filamentous algae such as Anacystis nidulans, Scenedesmus sp., Chlamydomonas sp., Clorella sp., Dunaliella sp., Euglena so., Prymnesium sp., Porphyridium sp., Synechoccus sp., Botryococcus braunii, Crypthecodinium cohnii, Cylindrotheca sp., Microcystis sp., Isochrysis sp., Monallanthus salina, M. minutum, Nannochloris sp., Nannochloropsis sp., Neochloris oleoabundans, Nitzschia sp., Phaeodactylum tricornutum, Schizochytrium sp., Senedesmus obliquus, and Tetraselmis sueica as well as algae belonging to any of Spirogyra, Cladophora, Vaucheria, Pithophora and Enteromorpha genera.

The term “fungi” as used herein includes, without limitations, a plurality of organisms such as molds, mildews and rusts and include species in the Penicillium, Aspergillus, Acremonium, Cladosporium, Fusarium, Mucor, Nerospora, Rhizopus, Tricophyton, Botryotinia, Phytophthora, Ophiostoma, Magnaporthe, Stachybotrys and Uredinalis genera.

As used herein, the term “fiber” refers to filamentous material that can be used in fabric and yarn as well as textile fabrication. One or more fibers can be used to produce a fabric or yarn. Fibers include, without limitation, materials such as cellulose, fibers of animal origin (e.g., alpaca, angora, wool and vicuna), hemicellulose, lignin, polyesters, polyamides, rayon, modacrylic, aramids, polyacetates, polyxanthates, acrylics and acrylonitriles, polyvinyls and functionalized derivatives, polyvinylidenes, PTFE, latex, polystyrene-butadiene, polyethylene, polyacetylene, polycarbonates, polyethers and derivatives, polyurethane-polyurea copolymers, polybenzimidazoles, silk, lyocell, carbon fibers, polyphenylene sulfides, polypropylene, polylactides, polyglycolids, cellophane, polycaprolactone, “M5” (poly{diimidazo pyridinylene (dihydroxy)phenylene}), melamine-formadehyde, plastarch, PPOs (e.g., Zylon®), polyolefins, and polyurethane.

The term “textile article” can include garments, fabrics, carpets, apparel, furniture coverings, drapes, upholstery, bedding, automotive seat covers, fishing nets, rope, articles including fibers (e.g., natural fibers, synthetic fibers, and combinations thereof), articles including yarn (e.g., natural fibers, synthetic fibers, and combinations thereof), and the like.

### Discussion:

In accordance with the purpose(s) of the present disclosure, as embodied and broadly described herein, embodiments of the present disclosure, in one aspect, relate to polymer compositions, methods of making polymer compositions, structures having the polymer composition covalently bonded to the surface of the structure, methods of attaching the polymer to the surface of the structure, methods of decreasing the amount of microorganisms formed on a structure, and the like. In an embodiment, the polymer composition (or the polymer disposed on a surface) has an antimicrobial characteristic (e.g., kills at least 70%, at least 80%, at least 90%, at least 95%, or at least 99% of the microorganisms (e.g., bacteria) on the surface and/or reduces the amount of microorganisms that form or grow on the surface by at least 70%, at least 80%, at least 90%, at least 95%, or at least 99%, as compared to a surface without the polymer composition disposed on the surface). Additional details are described in Example 1.

The structures can include those that are exposed to microorganisms and/or that microorganisms can grow on such as, without limitation, fabrics, cooking counters, food processing facilities, kitchen utensils, food packaging, swimming pools, metals, drug vials, medical instruments, medical implants, yarns, fibers, gloves, furniture, plastic devices, toys, diapers, leather, tiles, and flooring materials. The structures may also include live biologic structures (or surfaces of live biologic structures) such as seeds for agricultural uses, tree limbs, and trunk, as well as teeth. In an embodiment, the structure inherently includes C—H groups on the surface of the structure to interact with the polymer, as described below. In an embodiment, the structure includes a functionalized layer disposed on the structure that includes the C—H groups on the surface to interact with the polymer. In an embodiment, the structure can include surfaces that inherently include C—H groups on the surface of the structure and also can include surfaces that include a functionalized layer disposed on the structure that includes the C—H groups. In an embodiment, the functionalized layer can have a thickness of about 2 nanometers (nm) to 1 micrometer (μm) or about 25 nm to 120 nm.

In an embodiment, the structure can include textile articles, fibers, filters or filtration units (e.g., HEPA for air and water), packaging materials (e.g., food, meat, poultry, and the like food packaging materials), plastic structures (e.g., made of a polymer or a polymer blend), glass or glass like structures having a functionalized layer (e.g., includes a C—H group) on the surface of the structure, metals, metal alloys, or metal oxides structure having a functionalized layer (e.g., includes a C—H group) on the surface of the structure, a structure (e.g., tile, stone, ceramic, marble, granite, or the like) having a functionalized layer (e.g., includes a C—H group) on the surface of the structure, and a combination thereof. In an embodiment, the structure includes structures used in the fishing industry and these include fishing nets, fishing gear and tackle, fish, crab or lobster cages, and the like.

In an embodiment, the polymer is covalently bonded via the interaction of the polymer with a UV light (e.g., about 340 to 370 nm) that causes a C—C bond to form between the polymer and the surface having a C—H group or a layer on the surface having the C—H group. In other words, the polymer can be attached to the surface or the layer on the surface through a photochemical process so the bonding is easy and inexpensive to achieve. Once the covalent bonds are formed, the polymer layer is strongly bound to the surface and can withstand very harsh conditions such as sonication and extended washing steps as well as exposure to harsh environmental conditions (e.g., heat, cold, humidity, lake, river, and ocean conditions (e.g., above and/or under water), and the like).

In an embodiment, the polymer (also referred to as a “polymer composition”) includes a linear or branched polyethyleneimine polymer that has been quaternized with a hydrophobic side chain moiety and a photo cross-linkable moiety. In an embodiment, the molar ratio between hydrophobic side chain moiety and photo cross-linkable moiety can be about 99:1 to 10:90. In an embodiment, the polyethyleneimine polymer is a linear polyethyleneimine polymer that can include secondary amines. In an embodiment, the polyethyleneimine polymer is a branched polyethyleneimine polymer that can include primary, secondary, and/or tertiary amino groups.

In an embodiment, the polymer can have the following structure (Scheme 1):

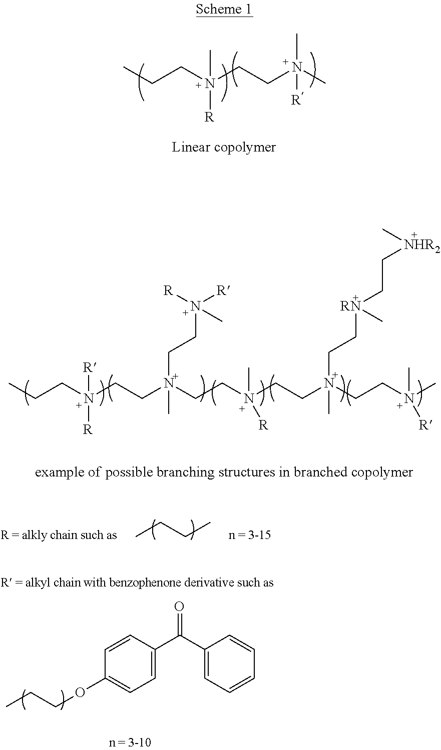

The above structure is for illustrative, non-limiting purposes. The structure of the polymer may take on other branching patterns, or comprise single or multiple sites for attachment to surfaces through a photochemical reaction. Schemes 2-3 below illustrate the formation of a polymer and attachments to a surface. Scheme 4 below describes how the polymer attaches to a surface.

In an embodiment, the counter anion on quaternary amine polymers can include different anions such as chloride, bromide, iodide, alkyl sulfate anions (e.g., methyl sulfate, ethyl sulfate, dodecylsulfate), tetrafluoroborate, and tosylate.

In an embodiment, the polymer composition that includes a linear or branched polyethyleneimine polymer that has been quaternized with a hydrophobic side chain moiety and a photo cross-linkable moiety, is blended with another, secondary polymer to form a polymer blend that can be directly used to manufacture polymers or polymer-based items or as a surface treatment, wherein (i) the secondary polymer can be any thermosetting or thermoplastic polymer, a finish material such as a resin or an adhesive, or other polymer cited herein or (ii) the secondary polymer of (i) may include an optional colored pigment.

In an embodiment, the polymer can have a molecular weight of about 20 kilodaltons to 5000 kilodaltons. In an embodiment, the polymer can have a molecular weight of about 50 kilodaltons to 1000 kilodaltons. In an embodiment, the polymer can have a molecular weight of about 50 kilodaltons to 500 kilodaltons. In an embodiment, the polymer can have a molecular weight of about 50 kilodaltons to 250 kilodaltons. In an embodiment, the polymer can have a molecular weight of about 50 kilodaltons to 150 kilodaltons. In an embodiment, the polymer can have a molecular weight of about 100 kilodaltons to 150 kilodaltons.

In an embodiment, the hydrophobic side chain moiety functions to at least provide a hydrophobic characteristic to the polymer. In an embodiment, the hydrophobic side chain can include a hydrocarbon chain such as: octane or its derivatives (e.g., 2-ethylhexane, 3-(methyl)heptane, 6-methylheptane, 2-methylheptane), decane or its derivatives (e.g., 3,7-dimethyl octane, 7-methyl nonane), dodecane or its derivatives (e.g., 4,8-dimethyl decane, 2-methyl undecane, 3-methyl undecane, 9-methyl undecane, 10-methyl undecane), tridecane or its derivatives (e.g., 2-methyl dodecane, 3-methyl dodecane, 6-methyl dodecane, 7-methyl dodecane, 8-methyl dodecane, 9-methyl dodecane, 10-methyl dodecane, 11-methyl dodecane), pentadecane or its deriatives (e.g., 3,7,11-trimethyl dodecane, 13-methyl tetradecane), hexadecane or its derivatives (e.g., 7-(methyl) pentadecane, 7-(3-propyl) tridecane), heptadecane or its derivatives (e.g., 11-methyl hexadecane, 14-methyl hexadecane, 2-methyl hexadecane), octadecane or its derivatives (e.g., 11-methyl heptadecane), nonadecane or its derivatives (e.g. 14-methyl octadecane) eicosane or its derivatives (e.g., 3,7,11,15-tetramethyl hexadecane, 9-(3-propyl)heptadecane), heneicosane or its derivatives (e.g., 20-methylheneicosane), docosane or its derivatives (e.g., 20-methyl heneicosane), tetraconsane (e.g., 11-methyl tricosane), and a combination thereof, where the combination can include a polymer that includes two or more different hydrophobic side changes. In an embodiment, one or more of the hydrocarbon chains can be substituted. In an embodiment, at least one C—H bond in the position alpha to the ammonium group can be replaced by an electronegative group selected from the group consisting of F, Cl, and Br. Examples of hydrophobic side chain moieties are described in Example 1.

In an embodiment, the photo cross-linkable moiety functions to at least undergo a photochemical change to covalently bond with a surface or a layer on the surface of a structure having a C—H group. In an embodiment, the polymer composition is covalently bonded via the interaction of the polymer with a UV light (e.g., about 250 nm to 500 nm or about 340 to 370 nm) that causes a C—C bond to form between the polymer and the surface or a layer on the surface having the C—H group. The UV light can be generated from a UV light source such as those known in the art.

In an embodiment, the photo cross-linkable moiety can include an aryl ketone (about 340 to 400 nm), an aryl azide group (about 250 to 450 nm or about 350 to 375 nm), a diazirine group (about 340 to 375 nm), and the polymer can include a combination of these groups. In an embodiment, the aryl ketone group can include benzophenone (about 340 to 380 nm), acetophenone (about 340 to 400 nm), a naphthylmethylketone (about 320 to 380 nm), a dinaphthylketone (about 310 to 380 nm), a dinaphtylketone derivative (about 320 to 420 nm), or derivatives of each of these. In an embodiment, the photo cross-linkable moiety is a benzophenone group. In an embodiment, the aryl azide group can include phenyl azide, alkyl substituted phenyl azide, halogen substituted phenyl azide, or derivatives of each of these. In an embodiment, the diazirine group can include 3,3 dialkyl diazirine (e.g., 3,3 dimethyl diazirine, 3,3 diethyl diazirine), 3,3 diaryl diazirine (e.g., 3,3 diphenyl diazirine), 3-alkyl 3-aryl diazirine, (e.g., 3-methyl-3-phenyl diazirine), or derivatives of each of these.

As mentioned above, the polymer can be disposed on a surface to produce a structure that includes the polymer covalently bonded (via a photochemical process) to the surface of the structure. In an embodiment, the method of disposing the polymer on the surface of the structure includes disposing the polymer on the surface using a method such as spraying, dipping, spin coating, drop casting, and the like. In an embodiment, the surface of the structure has C—H groups that can interact (e.g., form C—C bonds) with the polymer upon exposure to UV light. In an embodiment, the structure has a layer (also referred to as a “functionalized layer”) (e.g., a thin film or self assembling layer) disposed on the surface of the structure. The functionalized layer includes C—H bonds that can interact (form C—C bonds) with the polymer upon exposure to UV light. Additional details are described in Example 1. The structure can be exposed to UV light in many different ways such as direct exposure to a UV light source, exposure to UV light during the spray coating process, exposure to UV light during the dip coating process, exposure to UV light during the spincoating process, exposure to UV light during dip padding, exposure to UV light during nip padding, exposure to UV light during kiss rolling, and exposure to UV light during the drop-casting process.

Either during application of the polymer or once the polymer is disposed on the surface, UV light is directed onto the polymer on the surface. As described above, the UV light causes a photochemical reaction to occur between the polymer and the surface to form one or more covalent bonds (C—C bonds) between the polymer and the surface.

The wavelength of the UV light can be selected based on the photo cross-linkable moiety. In general, the UV light can be active to form the C—C bonds at about 250 to 500 nm, about 340 to 400 nm, or about 360 to 370 nm. The specific wavelength(s) that can be used for a particular photo cross-linkable moiety are described herein. In an embodiment, the UV light can be active to form the C—C bonds at a wavelength of about 340 to 370 nm. In an embodiment, the UV light can be active to form the C—C bonds at a wavelength of about 365 nm.

After the polymer is covalently bonded to the surface, the structure has an antimicrobial characteristic that is capable of killing a substantial portion of the microorganisms (e.g., bacteria) on the surface of the structure and/or inhibits or substantially inhibits the growth of the microorganisms on the surface of the structure. The phrase “killing a substantial portion” includes killing at least about 70%, at least about 80%, at least about 90%, at least about 95%, or at least about 99% of the microorganism (e.g., bacteria) on the surface that the polymer is covalently bonded. The phrase “substantially inhibits the growth” includes reducing the growth of the microorganism (e.g., bacteria) by at least about 70%, at least about 80%, at least about 90%, at least about 95%, or at least about 99% of the microorganisms on the surface that the polymer is covalently bonded, relative to a structure that does not have the polymer disposed thereon.

Once the structure has the polymer layer disposed on the entire surface or select portions of the surface, the structure can be exposed to the environment for which the structure is to be used. In an embodiment, the structure is used in the ocean, river, stream, collection pond, or lake. The structure can be introduced into the water and over a period of time the structure should have a smaller amount of microorganisms disposed on the structure relative to a structure without the polymer layer. Periodically, the structure can be exposed to the polymer material again to ensure that the previous polymer layer was not removed due to normal wear.

### EXAMPLES

### Experimental Materials

Silicon wafers (UniversityWafer.com) with native oxide and glass slides (VWR) (cut into 3.8×2.5 cm pieces) were used as substrates. Poly(2-ethyl-2-oxazoline) (Aldrich), tert-amylalcohol (Aldrich), 1-bromododecane (Alfa Aesar), iodomethane (Alfa Aesar), 4-hydroxybenzophenone (Alfa Aesar), 1,6 dibromohexane (Alfa Aesar), were used as received.

### Instrumental Methods

AFM experiments were performed using a Multimode Nanoscope IIIa (Digital Instruments/Veeco Metrology Group). All measurements were performed using tapping mode. Null ellipsometry was performed on a Multiskop (Optrel GbR) with a 632.8 nm He—Ne laser beam as the light source. Both δ and ψ value thickness data were measured and calculated by integrated specialized software. At least three measurements were taken for every layer, and the average thickness was calculated.

### Synthesis

Linear Polyethyleneimine (PEI): The deacylation reaction was performed according to literature procedure (PNAS, 2005, 102, 5679). 3 g of the Poly(2-ethyl-2-oxazoline, M_{w}, 50 kDa) (POEZ) was added to 120 mL of 24% (wt/vol) HCl, followed by refluxing for 96 h. The POEZ crystal dissolved completely in 1 h, but after overnight reflux, a white precipitate appeared. The precipitate was filtered and then air-dried. The resultant protonated PEI was dissolved in water and neutralized with aqueous KOH to precipitate the polymer. The white powder was isolated by filtration, washed with distilled water until the pH of the washed liquid became neutral, and dried under vacuum. Yield: 1.15 g (88%). ¹H NMR (CDCl₃): δ, 2.72 (s, 4H, NCH₂CH₂N), 1.71 (1H, NH).

Linear N,N-dodecyl methyl PEI: The linear quaternized PEI was synthesized according to the literature procedure (PNAS, 2006, 103, 17667). 1 g (23.5 mmol of the monomer unit) of the PEI was dissolved in 12 mL of tert-amyl alcohol, followed by the addition of 3.85 g (28.5 mmol) of K₂CO₃, and 16.5 mL (67 mmol) of 1-bromododecane, and the reaction mixture was stirred at 95° C. for 96 h. After removing the solids by filtration under reduced pressure, 2.8 mL of iodomethane was added, followed by string at 60° C. for 24 h in a sealed fluxed. The resultant solution was added to excess of ethylacetate; the precipitate formed was recovered by filtration under reduced pressure, washed with excess of ethylacetate and dried at room temperature under vacuum overnight. Yield: 3.2 g.

4-[(6-Bromohexyl)oxy]benzophenone: 4-Hydroxy benzophenone (5.94 g, 30 mmol), 1,6 dibromohexane (8.05 g, 33 mmol), potassium carbonate (5.95 g, 45 mmol) and DMF (60 mL) were stirred at room temperature for 16 h under inert atmosphere. The reaction mixture was poured into ice water (300 mL) and extracted with ether (100 mL). The organic layer was collected and the solvent was removed by rotary evaporator. The crude product was purified on silica gel column by using 10:1 hexane ethylacetate mixture. Yield: 8.2 g (76%). ¹H NMR (CDCl₃): δ, 7.81 (d, 2H, J=8.4 Hz), 7.75 (d, 2H, J=7.8 Hz), 7.54 (t, 1H, 7.5 Hz), 7.47 (t, 2H, J=6.9 Hz), 6.93 (d, 2H, J=9.0 Hz), 4.06 (t, 2H, J=6.3 Hz), 3.43 (t, 2H, 6.6 Hz), 1.86 (m, 4H), 1.50 (m, 4H). ¹³C NMR (CDCl₃): δ, 25.47, 28.10, 29.11, 32.86, 33.95, 68.2, 114.2, 128.37, 129.92, 129.94, 132.06, 132.78, 138.55, 162.9, 195.7.

1,6-Bis (4-benzoylphenoxy)hexane: 4-Hydroxy benzophenone (5.94 g, 30 mmol), 1,6 dibromohexane (3.66 g, 15 mmol), sodium hydroxide (1.8 g, 45 mmol) and DMF (30 mL) were refluxed for 6 h under inert atmosphere. The reaction mixture was cooled at room temperature, poured into ice water (300 mL) and extracted with ether (100 mL). The organic layer was collected and the solvent was removed by rotary evaporator. The crude product was purified on silica gel column by using 10:1 hexane ethylacetate mixture. Finally compound was crystallized from DCM/hexane solvent mixture. Yield: 5.1 g (71%). ¹H NMR (CDCl₃): δ, 7.82 (d, 4H, J=7.7 Hz), 7.75 (d, 4H, J=7.5 Hz), 7.56 (t, 2H, 7.2 Hz), 7.47 (t, 4H, J=7.2 Hz), 6.95 (d, 4H, J=9.0 Hz), 4.06 (m, 4H), 1.87 (br, 4H), 1.55 (br, 4H). ¹³C NMR (CDCl₃): δ, 26.06, 29.28, 43.52, 114.19, 114.22, 128.38, 129.90, 129.92, 132.06, 132.78, 138.72, 162.97.

Linear Copolymer of N,N-dodecyl methyl and N,N-[(6-hexyl)oxy]benzophenone methyl PEI: 0.5 g (12 mmol of the monomer unit) of the PEI was dissolved in 6 mL of tert-amyl alcohol, followed by the addition of 2.1 g (15 mmol) of K₂CO₃, 1.97 g (8 mmol) of 1-bromododecane, and 1.44 g of 4-[(6-bromohexyl) oxy]benzophenone and the reaction mixture was stirred at 95° C. for 96 h. After removing the solids by filtration under reduced pressure, 1.5 mL of iodomethane was added, followed by string at 60° C. for 24 h in a sealed fluxed. The solution was dried under rotary evaporator. The yellow solid was dissolve in minimum volume of dichloromethane and then added excess hexane to precipitate the polymer. Light yellow solid was filtered and dried at room temperature under vacuum for overnight. Yield: 2.3 g (46%). ¹H NMR (CDCl₃): δ, 7.76 (bs, 4H); 7.56 (bs, 1H), 7.45 (bs, 2H); 6.98 (bs, 2H); 4.91-3.26 (m, 21H); 1.82 (bs, 6H); 1.65 (bs, 16H); 1.23 (bs, 34H), 0.66 (bs, 6H).

Preparation of self-assembled monolayers (SAM) on glass substrates: Glass slides were cut into rectangles. The substrates were sonicated with Fisherbrand sonicating soap, 18.2 M) deionized water, isopropanol, and acetone for 10 min each and finally dried in an oven for 1 h. After cleaning, a self-assembled monolayer of 7-octenyl trichlorosilane was formed from the vapor phase by suspending the substrates in a vacuum dessicator and placing two drops of silane on a glass substrate at the bottom. The substrates were kept in a vacuum flux constant pressure (100 millitorr) for 20 min. After venting with nitrogen, the substrates were sonicated with acetone and dried under air.

Surface bound PEI Polymer (2a): 15 mg of quaternized PEI polymer and 10 mg of dibenzophenone was dissolved in 1 mL of chloroform solvent. The solution was filtered through 0.25 μm filter. The polymer film was developed on functionalized glass substrate by spin coating with 0.5 mL of solution at 1000 rpm. The glass substrate was radiated with UV light (360 nm, 180 mW/cm²) for 15 minutes to covalently bound the polymer on glass surface with benzophenone as linker. The substrate was sonicated with acetone for one min and dried under air.

Surface bound PEI Polymer (2b): 15 mg of quaternized polymer (2b) was dissolved in 1 mL of chloroform solvent. The solution was filtered through 0.25 μm filter. The polymer film was developed on functionalized glass substrate by spin coating with 0.5 mL of solution at 1000 rpm. The glass substrate was radiated with UV light (360 nm, 180 mW/cm²) for 15 mins to covalently bound the polymer on glass surface with benzophenone as linker. The substrate was sonicated with acetone for one min and dried under air.

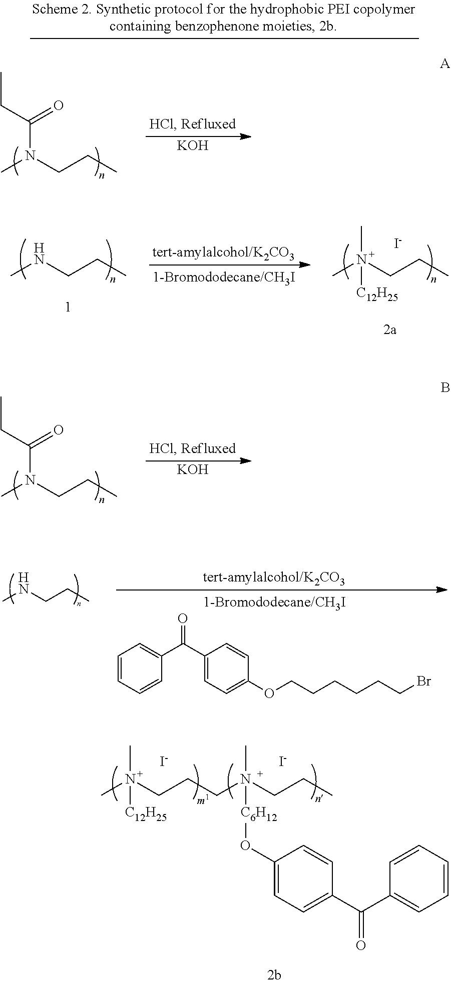

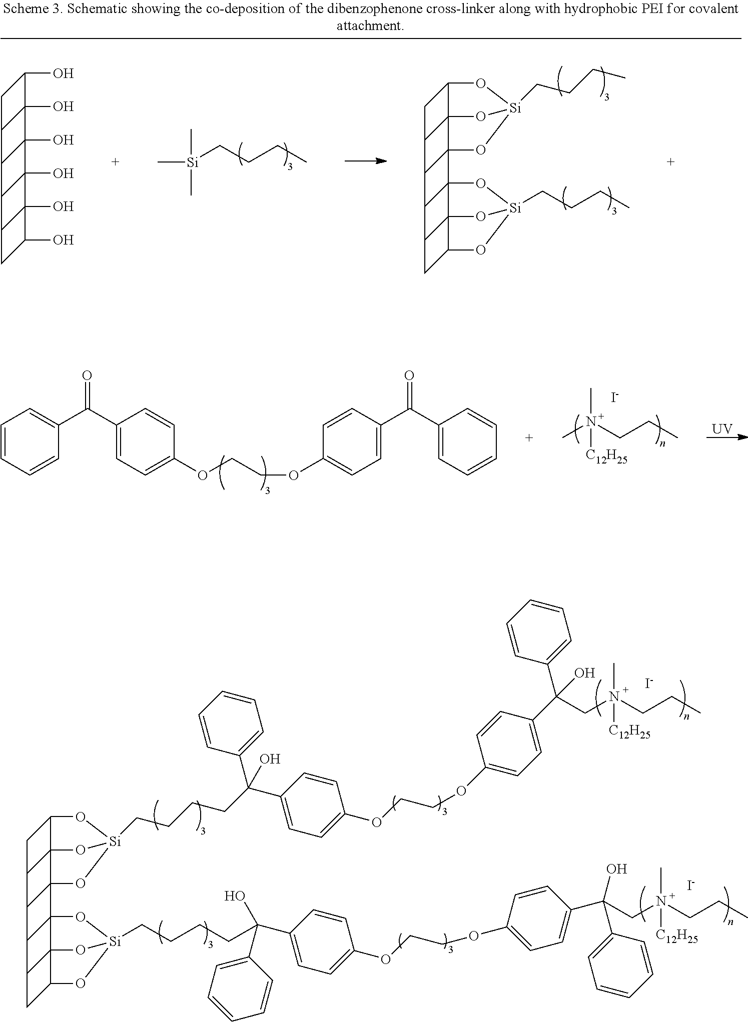

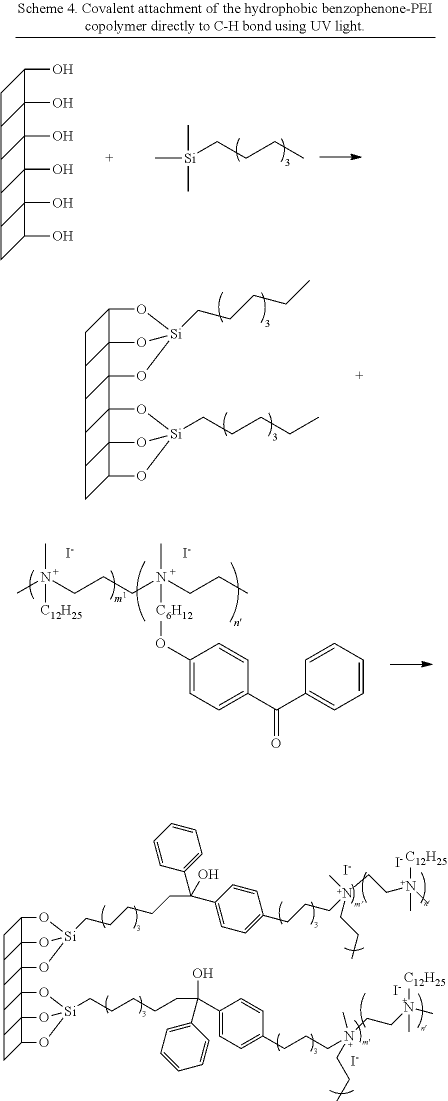

### Antimicrobial Test Method:

Trypticase Soy Broth (TSB) (10 ml) was inoculated with one loopful of Staphylococcus aureus culture and incubated overnight in a water shaker bath at 37° C. with 45 linear strokes per minute (TSB contains 17 g of casein peptone, 3 g of soy meal peptone, 2.5 g of D-(+) glucose, 5 g of NaCl and 2.5 g of dipotassium hydrogen phosphate per liter). 100 μl of an overnight Staphylococcus aureus culture was again inoculated with 10 ml of TSB and incubated for 4 hours in above mentioned conditions in the shaker bath. From freshly prepared 4 hour microbe culture 1 ml was transferred to 1.5 ml centrifuge tube. The tube was centrifuged at 5000 rpm for 1 minute at 21° C. (Centrifuge=accuSpin Micro 17R, Fisher Scientific, Tubes=Micro Centrifuge Tube, VWR International). The supernatant solution was discarded and fresh 1 ml of sterile water was added to the precipitated microbe tube. The microbes were re-suspended in the solution by using vortex mixer (Vortex Mixer=Vortex Genie 2). This re-suspended solution was transferred to 9 ml sterile water. The re-suspended solution was diluted ten times to get ˜3.4×10⁶ colony forming units/ml (CFU/ml). Approximately 5 ml of this diluted solution was transferred to TLC sprayer bottle. The TLC sprayer bottle was connected to EFD (1500XL) pneumatic dispense regulator. The polymer coated substrates were uniformly sprayed in a controlled fashion from the TLC sprayer for 1 second at 30-40 psi pressure. The distance between the sprayer and glass slide was approximately 1-1½ feet. The sprayed sample was air dried for approximately 2 minutes and carefully mounted a sprayed surface of the sample on a Difco™ Trypticase Soy Agar (TSA) plate (TSA contains 15.0 g of pancreatic digest of casein, 5.0 g of enzymatic digest of soyabean meal, 5.0 g of sodium chloride, and 15.0 g of agar per liter). TSA plates were incubated for 24 hours at 37° C. Finally the number of colonies grown on the slide was observed.

### Launder-O-Meter Testing:

Approximately 1 sq inch of net samples was used for testing. The net sample was coated with 15 mg/ml of polymer 2b dissolved in acetone. The dissolved polymer solution was applied through spray coating and dabbing polymer solution soaked sponge on the both sides of net samples. Uncoated sample was used as control. Three replications were done for coated sample. Each sample was treated with 150 ml of 35 gpl (gram/liter) saline solution (NaCl) along with 50 steel balls (6 mm in diameter). The treatment was given in a closed stainless steel canister (500 ml, 75×125 mm) on an Atlas Launder-o-meter (AATCC standard instrument) at 49° C. for 45 minutes. The samples were rinsed with water and were tested for antibacterial efficacy.

### Result and Discussions

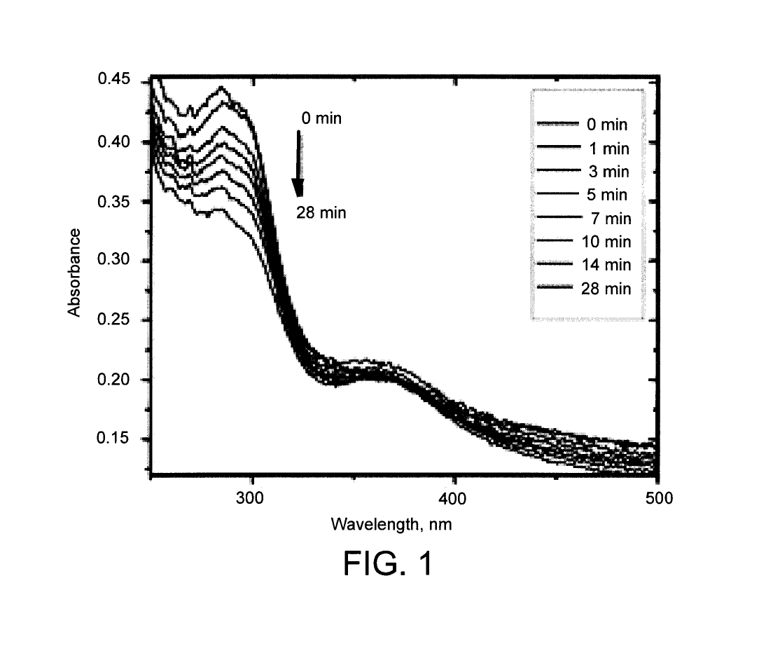

Two quaternary amine polymer have been synthesized (2a and 2b) (FIG. 1) with (2b) and without (2a) attachment of a benzophenone moiety. Polymer 2a was synthesized according to the literature procedure (Proceedings of the National Academy of Science 2006, 103, 17667-17671, which is incorporated by reference). Another polymer 2b was prepared by reacting PEI polymer with 4-[(6-Bromohexyl) oxy]benzophenone and 1-bromododecane. The copolymer composition was checked by NMR spectroscopy, which revealed that the polymer composition matched the monomer feed ratio. Polymer 2a is soluble in halogenated solvents but insoluble in alcohols, where as polymer 2b is soluble in halogenated solvents and slightly soluble in alcohols. Polymer 2b is also readily soluble in acetone. Our strategy is to photochemically attach the polymer material onto the surface by using the benzophenone (BP) moiety as a cross-linker. Benzophenone is an ideal candidate for cross-linking because it is (1) useful for any organic surface or surface functionalized with an organic molecule which has a C—H bond; (2) it can be activated using very mild UV light (˜345-360 nm), avoiding oxidative damage to the polymer and substrate by exposure to shorter wavelengths. (3) Benzophenone is chemically more stable than other organic crosslinkers and reacts preferentially with C—H bonds in a wide range of different chemical environments. Triggered by UV light, benzophenone has an n-π* transition, resulting in the formation of a biradical triplet excited state that then abstracts a hydrogen atom from neighboring aliphatic C—H group to form a new C—C bond.

While this mechanism provides the ability to coat any type of polymeric surface, we have used glass surfaces and silicon wafers to do the preliminary biocidal experiments because of the ease of surface analytical quantification. These substrates allow us to measure coating thickness and to observe changes in surface morphology upon irradiation with UV light. The substrates are coated with a self-assembled monolayer of organic silane to provide reactive C—H groups that will mimic plastic functionalization, while retaining very low roughness for accurate measurements of thickness. Fabrication of covalently bound polymer surfaces is shown in Scheme 3 and 4. In both cases, glass or silicon surfaces were functionalized with octyltrichlorosilane to generate C—H groups on the surface. This can be done with any trichloro-, trimethoxy-, or triethoxy-alkylsilane derivative. To this modified surface a thin layer of polymer 2a with dibenzophenone (Scheme 3) or polymer 2b was applied using a spin coater. This was to ensure smooth coating and a uniform film thickness. In the last step, the desired covalently attached films were generated by crosslinking through the benzophenone group with UV irradiation. To remove unbound materials, films were washed with acetone or sonicated in acetone for one minute. The thicknesses were measured for polymer film 2b before and after sonication and were 122 and 65 nm respectively. It is important to note that the polymers will covalently attach to any organic substrates with a C—H bond (examples are cotton, polyethylene, polypropylene, or other common plastics). In these cases, the covalently attached polymer surface can be generated without any funtionalization because of the presence of C—H group on the surface.

The kinetics of surface attachment of the PEI copolymers with different irradiation times was investigated by UV-vis spectroscopy. Changes in the absorption spectra of the polymer film with 2b under UV light irradiation are shown in FIG. 1. Focusing on the BP photophore, absorption of a photon at 350 nm results in the promotion of one electron from a nonbonding sp² to an antibonding π*-orbital of the carbonyl group. In the diradicaloid triplet state, the electron-deficient oxygen n-orbital is electrophilic and therefore interacts with weak C—H δ-bonds, resulting in hydrogen (H) abstraction to complete the half-filled n-orbital. To confirm the photochemical attachment, we investigated the absorption spectroscopy with UV irradiation time. The π-π* absorption of benzophenone at 290 nm decreases with increasing irradiation time, indicating the decomposition of carbonyl group through the above photochemical reaction.

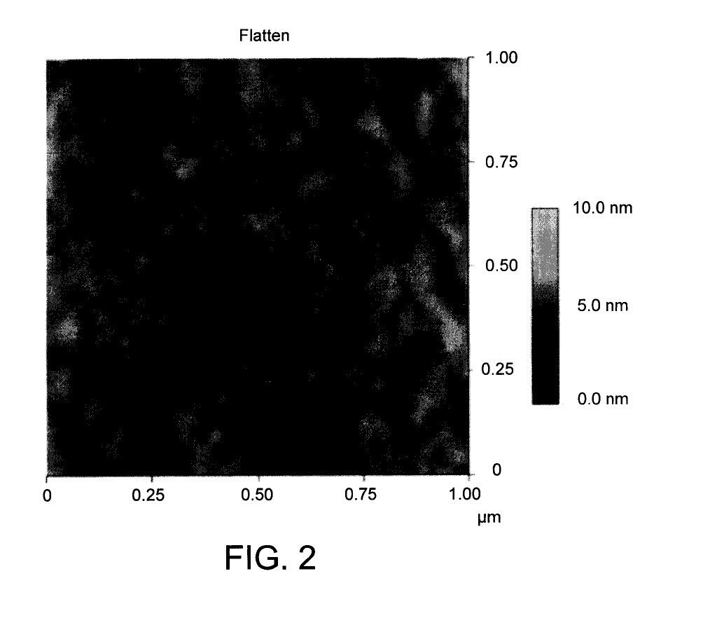

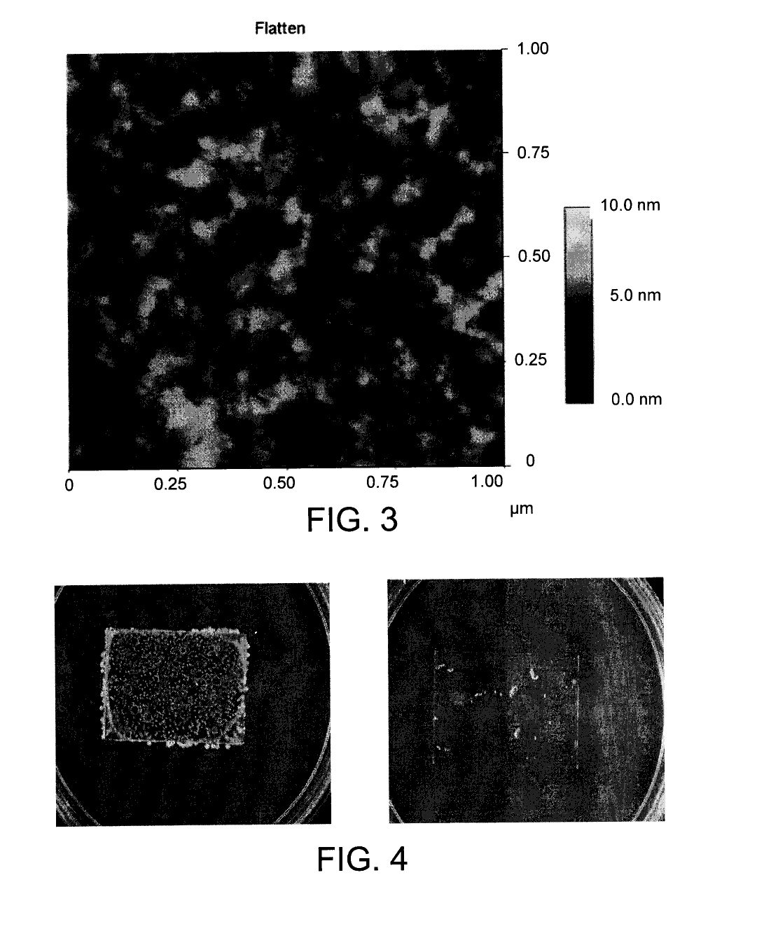

Atomic force microscopy (AFM) was use to characterized the surface morphology of polymer (2b) film before and after sonication to remove any non-covalently bound polymer from the surface. Before sonication, the polymer film was very smooth. A representative morphology for the film before sonication is shown by FIG. 2, which has an RMS roughness 0.48 nm. This is approximately the roughness of the glass substrate (0.39 nm) before functionalization. FIG. 3 shows the AFM image of the film after sonication. Though the basic morphology of surfaces are same before and after sonication, the roughness (0.83 nm) has slightly increased with sonication due to the removal of any non-covalently attached polymer from the surface. The AFM measurements, along with the thickness values measured with ellipsometry confirm the attachment of the polymer to the substrate surface.

The ability of the polymer-coated surfaces to kill bacteria was tested for different textile woven and non-woven fabrics and glass substrates. The density of the quaternized amine polymer played an important role in the biocidal activity (Table 1). We examined the surfaces with a coating varying from 10 to 65 nm in thickness. The surface grafted with a high density of polymers exhibited relatively high biocidal activity. When the thickness of the polymer layer is greater than 50 nm, essentially all the bacteria are killed. FIG. 4 shows the digital photograph of the control and polymer functionalized surfaces incubated with bacteria. As seen in FIG. 4a, numerous colonies of S. aureus grown on the control slide after spraying the bacterial suspension onto its surface. On the other hand no colonies were found on the polymer functionalized surface (FIG. 4b).

TABLE 1
There were four sets of samples tested: 1. Control Glass,
2. Spin coated glass slide with 5 mg/ml polymer concentration,
3. Spin coated glass slide with 10 gm/ml polymer, and Spin
coated glass slide with 15 mg/ml concentration.

| | | 5 mg/ml | 10 mg/ml | 15 mg/ml |
|---|---|---|---|---|
| | Control | Polymer coated | Polymer coated | polymer coated |
| Rep. | glass | Glass (22 nm) | Glass (50 nm) | glass (65 nm) |
| 1 | TMTC | 30 | 15 | 0 |
| 2 | TMTC | 42 | 18 | 0 |
| 3 | TMTC | 29 | 12 | 0 |

The different concentrations allow control over different thickness values. The copolymer (2b) was spin coated on the glass sample and UV irradiated with 360 nm light of an intensity 180 mW/cm² and then sonicated for 1 minute. The coated and control samples were sprayed with S. aureus solution. TMTC ~ too many to count.

TABLE 2
There were four sets tested 1. Control cotton sample, 2. Polymer
spray coated cotton sample without UV radiation, 3. Polymer spray
coated cotton sample with UV radiation, and 4. Polymer spray coated
cotton sample with UV radiation and acetone washed.

| | | No UV | UV radiation | Acetone |
|---|---|---|---|---|
| | | radiation | & No wash | washed |
| | Control | (Polymer conc. | (Polymer conc. | (Polymer conc. |
| Rep. | Cotton | 15 mg/ml) | 15 gm/ml) | 15 gm/ml) |
| 1 | TMTC | 10 | 0 | 7 |
| 2 | ~150 | 6 | 5 | 0 |
| 3 | ~300 | 0 | 8 | 1 |
| Average | 225 | 8 | 6.5 | 4 |
| % Reduction | — | 96.44 | 97.11 | 98.22 |

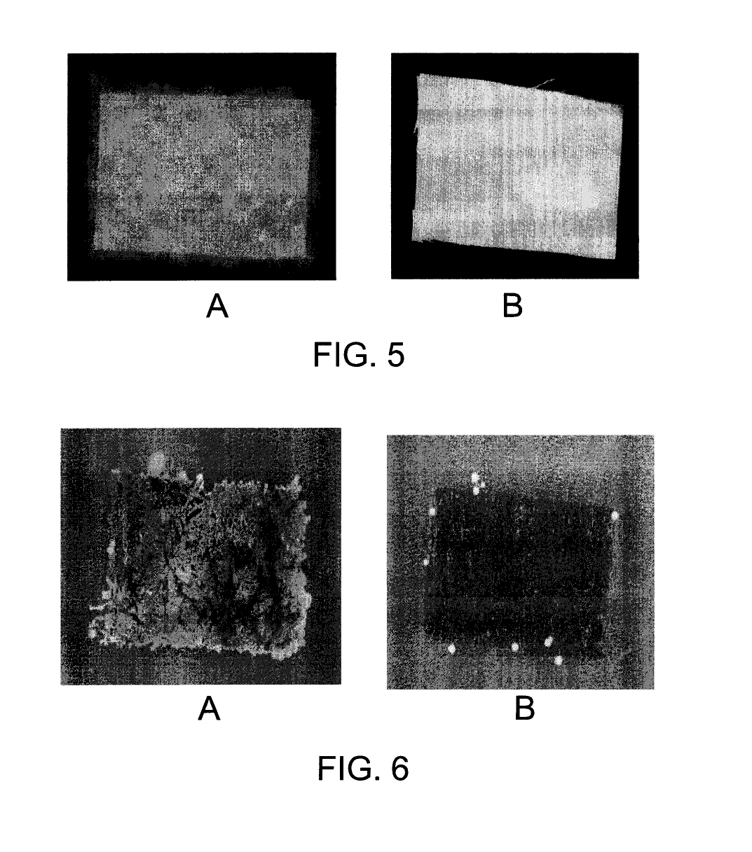

Microbe Tested: Staphylococcus aureus (gram positive bacteria). Digital images are shown in FIG. 5.

TABLE 3
There were two sets tested with Escherichia coli
(gram negative bacteria) 1. Control glass slide
and 2. Glass substrate with 65 nm thick polymer 2b.

| | Control | |
|---|---|---|
| Rep. | Glass | Substrate |
| 1 | ~280 | 0 |
| 2 | TMTC | 0 |
| 3 | ~100 | 0 |
| Average | 190 | 0 |
| % Reduction | — | 100 |

TABLE 4
There were three sets tested: 1. Control polypropylene substrate
(Ten Cate Nicolon geosynthetic product), 2. Polymer spray
coated and UV irradiated sample and 3. Polymer spray coated,
UV irradiated and acetone washed sample.

| | | | UV radiated |
|---|---|---|---|
| Rep. | Control | UV radiated | Acetone washed |
| 1 | TMTC | 6 | 31 |
| 2 | TMTC | 7 | — |
| 3 | TMTC | 12 | — |

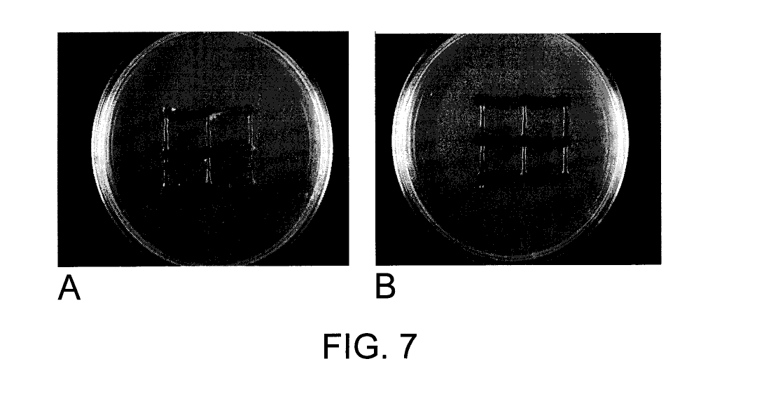

Microbe Tested: Staphylococcus. aureus (gram positive bacteria). Digital pictures are shown in FIG. 6.

Launder-o-meter testing: The durability of coating was analyzed through launder-o-meter test. There were three different sets of substrates used namely, (1) PVC coated net samples as a control, (2) PVC net coated samples coated with polymer 2b and UV radiated and (3) PVC net coated samples coated with polymer 2b and UV radiated and laundered using above mentioned procedure. The laundered sample showed less microbial growth compared to control samples. The number of colonies on samples was not countable. The digital pictures are shown in FIG. 7.

### Example 2

Testing in aquatic environments: The effectiveness of the polymer coating on polyvinylchloride substrates was tested by submerging 1 m² of the substrates shown in FIG. 7 in the southern (off the Chilean coast) and northern (off the Canadian coast) hemispheres to account for seasonal variations in aquaculture environments. The substrates were examined after 30 and 60 days of testing. The substrates that were coated with polymer 2b were effective at preventing bacteria adsorption on the polymer substrates. After 30 days, the uncoated samples were completely covered with bacteria, algae, barnicles, and other sea creatures, while the substrates coated with polymer 2b were free of fouling, except for a thin film of dead bacteria. After 60 days, the 2b coated substrates had succumbed to bacterial adsorption because of biofouling on the dead bacteria surface. This coating of bacteria and algae was easily wiped away, while the fouled, uncoated substrates, were very difficult to clean by hand, and required excessive pressure washing with a stream of high pressure water.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

1. A polymer comprising:
a linear or branched polyethylenimine polymer that has been quaternized with a hydrophobic side chain moiety and a photo cross-linkable moiety.

2. The polymer of claim 1, wherein the hydrophobic side chain is selected from the group consisting of: hexane; heptane; octane; nonane; decane; undecane; dodecane; tridecane; tetradecane; pentadecane; hexadecane; heptadecane; heptadecane; octadecane; eicosane; heneicosane; docosane; tricosane; and a combination thereof.

3. The polymer of claim 1, wherein the photo cross-linkable moiety is selected from the group consisting of: an aryl ketone, an aryl azide group, a diazirine group, and a combination thereof.

4. The polymer of claim 3, wherein the aryl ketone is selected from the group consisting of: acetophenone, an acetophenone derivative, benzophenone, a benzophenone derivative, a naphtylmethylketone, a dinaphtylketone, a dinaphtylketone derivative, and a combination thereof.

5. The polymer of claim 4, wherein the photo cross-linkable moiety is a benzophenone group.

6. The polymer of claim 1, wherein the polymer has a molecular weight of about 20 kilodaltons to 5000 kilodaltons.

7. The polymer of claim 1, wherein the polymer has a molecular weight of about 100 kilodaltons to 150 kilodaltons.

8. The polymer of claim 3, wherein the hydrophobic side chain is selected from the group consisting of: hexane; heptane; octane; nonane; decane; undecane; dodecane; tridecane; tetradecane; pentadecane; hexadecane; heptadecane; heptadecane; octadecane; eicosane; heneicosane; docosane; tricosane.

9. The polymer of claim 1, wherein the polyethylenimine polymer is a linear polyethylenimine polymer.

10. The polymer of claim 1, wherein the polyethylenimine polymer is a branched polyethylenimine polymer.

11. The polymer of claim 1, wherein the molar ratio between hydrophobic side chain moiety and photo cross-linkable moiety can be a range from about 99:1 to 10:90

12. A method of disposing a polymer on a surface, comprising:
providing a polymer of claim 1;
disposing the polymer on a structure having a surface having C—H groups; and
exposing the polymer to a UV light, wherein the interaction of the polymer with the UV light causes the polymer to covalently bond with the surface.

13. The method of claim 12, wherein the UV light has a wavelength of about 200 to 500 nm.

14. The method of claim 12, wherein the UV light has a wavelength of about 340 to 380 nm.

15. The method of claim 12, wherein the UV light has a wavelength of about 365 nm.

16. The method of claim 12, wherein the surface is selected from a group consisting of: a polymer surface, a metal surface having a functionalized layer on the surface, and a glass surface having a functionalized layer on the surface.

17. The method of claim 16, wherein the functionalized layer includes C—H groups on the surface.

18. The method of claim 16, wherein the interaction of the polymer with the UV light causes a C—C bond to be formed between the polymer and the surface or a layer on the surface.

19. The method of claim 12, wherein the structure is selected from the group consisting of: a fabric, a textile article, a natural fiber, a synthetic fiber, a porous membrane, a plastic structure, a oxide structure having a functionalized layer on the surface of the structure, a metal structure having a functionalized layer on the surface of the structure, a glass structure having a functionalized layer on the surface of the structure, and a combination thereof.

20. A structure, comprising:
a surface having a polymer of claim 1 covalently attached to the surface, wherein the structure has an antimicrobial characteristic.

21. The structure of claim 20, wherein the antimicrobial characteristic causes a substantial amount of microorganisms to be killed

22. The structure of claim 20, wherein the microorganism is bacterium, and wherein the bacterium is selected from the group consisting of: gram positive bacteria, gram negative bacteria, protozoan, fungi, and algae.

23. The structure of claim 20, wherein the antimicrobial characteristic causes a microorganism growth to be inhibited or substantially inhibited,

24. The structure of claim 23, wherein the microorganism is bacterium, and wherein the bacterium is selected from the group consisting of: gram positive bacteria, and gram negative bacteria.

25. The structure of claim 20, wherein the structure is selected from the group consisting of: a fabric, a textile article, a natural fiber, a synthetic fiber, a porous membrane, a plastic structure, a oxide structure having a functionalized layer on the surface of the structure, a metal structure having a functionalized layer on the surface of the structure, a glass structure having a functionalized layer on the surface of the structure, and a combination thereof.

26. The structure of claim 20, wherein the functionalized layer can have a thickness of about 2 nanometers (nm) to 1 micrometer (μm).

27. The structure of claim 20, wherein the antimicrobial characteristic of the surface is characterized in that it kills greater than about 90% of the microorganisms on the surface.

28. The structure of claim 20, wherein the antimicrobial characteristic of the surface is characterized in that it kills greater than about 99% of the microorganisms on the surface.

29. The polymer of claim 8, wherein at least one C—H bond in the position alpha to the ammonium group has been replaced by an electronegative group selected from the group consisting of F, Cl, and Br.
